(19) United States
(12) Patent Application Publication
(10) Pub. No.: US 2018/0049942 A1
(43) Pub. Date: Feb. 22, 2018

(54) INTERACTIVE DEVICE AND ORGAN EMULATION DEVICE USED THEREIN

(71) Applicant: PERFECT SHINY TECHNOLOGY (HK) LIMITED., HONG KONG (CN)

(72) Inventors: Ming Kwong Chan, Hong Kong (CN); Shih-Hsien Hu, New Taipei City (TW)

(21) Appl. No.: 15/677,142

(22) Filed: Aug. 15, 2017

(30) Foreign Application Priority Data
Aug. 19, 2016 (CN) 201610697387.X
Jan. 17, 2017 (CN) 201710031100.4

(51) Int. Cl. A61H 19/00; G06F 3/147; G06F 3/16

(52) U.S. Cl. CPC A61H 19/32; A61H 19/44; A61H 2201/1207; G06F 3/16; A61H 2230/085; G06F 3/147

(57) ABSTRACT

An interactive device includes an organ emulation device for contact with a body part of a user; a capacitive sensing device disposed in the organ emulation device for sensing a relative motion of the body part of the user to the organ emulation device and outputting a sensing signal corresponding to the relative motion; and a multimedia device in communication with the capacitive sensing device for receiving the sensing signal, and outputting a multimedia signal based on an information indicated by the sensing signal so as to respond to the relative motion. The interactive device exhibits enhanced virtual reality effects.

### FIELD OF THE INVENTION

The present invention relates to an interactive device and an organ emulation device for use in an interactive device. In particular, the interactive device and the organ emulation device can be used with a multimedia device such as a virtual reality.

### BACKGROUND OF THE INVENTION

Adult-toy-related industry is continuously developing and advancing, and according to different needs, there may be a variety of applications, e.g. artificial vagina, artificial penis, etc. For simulating a human organ, an adult toy is usually made of silica gel or other soft material having similar characteristics to the human body. Sometimes, a lubricant is used as an auxiliary. Meanwhile, virtual reality and related interactive audio and video games are also under rapid development. Nevertheless, the virtual reality of commercially available adult toys and related interactive video games seem to have not yet been satisfactory, and need to be further improved.

### SUMMARY OF THE INVENTION

Therefore, the present invention provides an interactive system with enhanced virtual reality.

An aspect of the present invention relates to an interactive device, comprising: an organ emulation device for contact with a body part of a user; a capacitive sensing device disposed in the organ emulation device for sensing a relative motion of the body part of the user to the organ emulation device and outputting a sensing signal corresponding to the relative motion; and a multimedia device in communication with the capacitive sensing device for receiving the sensing signal, and outputting a multimedia signal based on an information indicated by the sensing signal so as to respond to the relative motion.

Another aspect of the present invention relates to an organ emulation device for use with a multimedia device, comprising: a main body for contact with a body part of a user; and a capacitive sensing device disposed in the main body for sensing a relative motion of the body part of the user to the organ emulation device and outputting a sensing signal corresponding to the relative motion to the multimedia device to have the multimedia device dynamically respond to the relative motion.

### BRIEF DESCRIPTION OF THE DRAWINGS

The invention will become more readily apparent to those ordinarily skilled in the art after reviewing the following detailed description and accompanying drawings, in which:

FIG. 1 is a functional block diagram schematically illustrating an interactive device according to an embodiment of the present invention;

FIG. 2 is a schematic diagram illustrating an example of a capacitive sensing electrode for use in the interactive device as shown in FIG. 1;

FIG. 3 is a plot schematically illustrating how a sensing capacitance data correlates to a tip position of a sensed object;

FIG. 4 is a functional block diagram schematically illustrating an interactive device according to another embodiment of the present invention; and

FIG. 5 is a schematic diagram illustrating an interactive device according to a further embodiment of the present invention.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

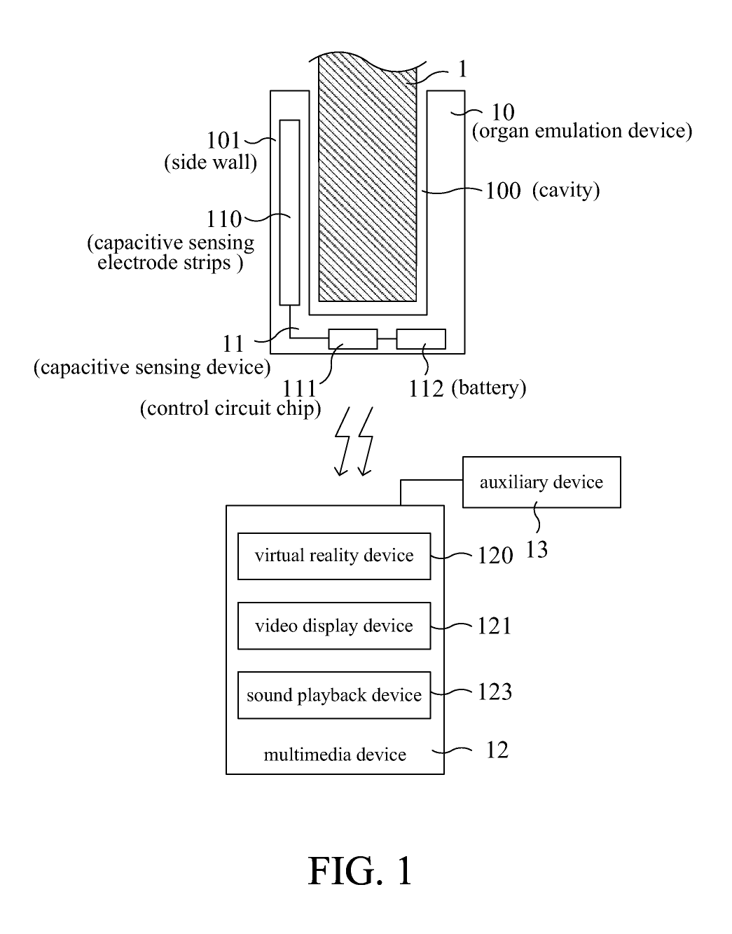

Please refer to FIG. 1, which schematically illustrates an embodiment of an interactive device proposed in accordance with the present invention. The interactive device comprises an organ simulation device 10 whose main body can be in contact with a part 1 of a human body; and a capacitive sensing device 11 disposed in the main body of the organ simulation device 10 for sensing a relative motion between the human body part 1 and the organ simulation device 10. In response to the sensed motion, a sensing signal is generated and outputted to an external multimedia device 12 in communication with the capacitive sensing device 11 wirelessly or through a wire, or by way of any other suitable communication means. The external multimedia device 12, when receiving the sensing signal, adaptively outputs a multimedia signal to reflect the information of the relative motion, which is carried by the sensing signal. For example, the organ simulation device 10 may be an artificial vagina mainly made of a soft material, e.g. silica gel, or a material exhibiting similar functions, and may be used together with a lubricant.

To avoid the capacitive sensing device 11 from being contaminated with the lubricant, the capacitive sensing device 11 is preferably built in the organ emulation device 10. The capacitive sensing device 11 comprises a plurality of capacitive sensing electrode strips 110, a control circuit chip 111, and a battery 112. As shown, the capacitive sensing electrode strips 110 are disposed on the side wall 101 of a cavity 100 of the organ emulation device 10 for sensing the relative motion between the user 1 and the organ simulation device 10, e.g. an in/out piston-like action. In response to the sensed motion, a capacitance change would be rendered. The control circuit chip 111 is electrically connected to the capacitive sensing electrode strips 110 and outputs a sensing signal according to the capacitance change of the capacitive sensing electrode strips 110.

The capacitive sensing electrode strips 110 can sense a capacitive difference between a target object such as human body and air in a hollow space, which exhibit respective capacitive characteristics. The control circuit chip 111 can determine a position of the target object in the cavity 100, e.g. depth into the cavity, according to the sensed result of the capacitive sensing electrode strips. On the other hand, it is not necessary that the entirety of the organ simulation device 10 is made of a non-shielding material having a high dielectric coefficient. Instead, it would be enough to provide the non-shielding and high-dielectric-coefficient material on a container side wall where the capacitive sensing electrode strips 110 is located.

Since the capacitive sensing electrode strips 110 used in the embodiment are capable of conducting non-contact touch sensing, the control circuit chip 111 electrically connected to the capacitive sensing electrode strips 110 can determine the position of the target object. The details of the above-described capacitive sensing electrode strips 110 and the control circuit chip 111 may be referred to those previously filed and assigned to the same assignee. For example, Chinese Patent Application No. 201410526889.7 filed Oct. 9, 2014, and Chinese Patent Application No. 201410611424.1 filed Nov. 4, 2014 have relevant disclosures. In order to optimize the resolution of the one-dimensional length measurement, the capacitive sensing electrode strips 110 can also be measured in the following way. Firstly, a plurality of separate electrodes are arranged in one dimension for respective sensing operations. Then the respective sensed capacitance data are used to estimate the position of the target object. Afterwards, the electrode grouping technique is used to accurately calculate the position of the front end of the target object.

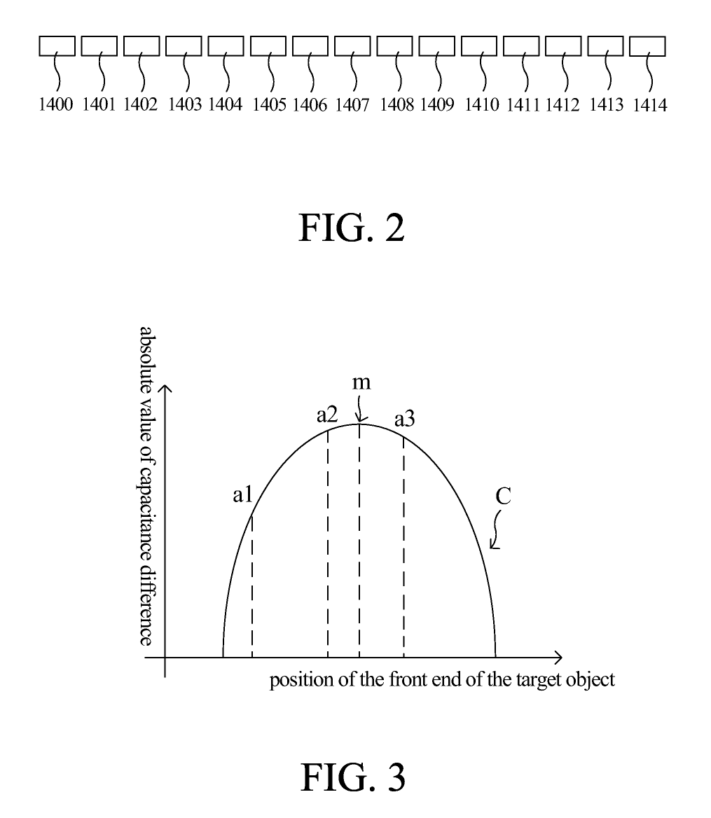

As shown in FIG. 2, an embodiment of the present invention may utilize a capacitance difference between adjacent two of fifteen separate electrodes 1400-1414 arranged in an axial direction to estimate the position of the front end of the target object. In more detail, a plurality of sets of capacitance differences are obtained by comparing pairs of adjacent separate electrodes, e.g. a capacitance difference between electrodes 1400 and 1401, and a capacitance difference between electrodes 1401 and 1402, etc. When a pair of adjacent electrodes show substantially zero capacitance difference therebetween, it is determined that the adjacent electrodes are both affected or both unaffected by the target object. On the other hand, when a pair of adjacent electrodes show a relatively large capacitance difference therebetween, e.g. larger than the capacitance difference of any other pair of adjacent electrodes, it is determined that the two electrodes are positioned at opposite sides of the front edge of the target object, respectively, i.e. one inside and the other outside the area. In other words, by locating the pair of adjacent electrodes that have extremum capacitance difference, the front end of the target object can be located accordingly. For example, assuming the electrodes 1408 and 1409 have substantially the largest capacitance difference therebetween, it is determined that the front end of the target object would lie between the electrodes 1408 and 1409. In order to more accurately locate the front end of the target object, the measurement and estimation can be alternatively or further performed with grouped electrodes under the control of the control circuit chip. For example, three electrodes are parallelly connected as a grouped electrode having a bigger equivalent area. The grouped electrode would have improved sensing capacitance so as to improve estimating accuracy.

In more detail, a group of three adjacent electrodes 1405, 1406 and 1407 electrically connected in parallel and another group of three adjacent electrodes electrically connected in parallel 1408, 1409 and 1410 have a first sensing capacitance difference with an absolute value a1; a group of three adjacent electrodes 1406, 1407 and 1408 electrically connected in parallel and another group of three adjacent electrodes 1409, 1410 and 1411 electrically connected in parallel have a second sensing capacitance difference with an absolute value a2; and a group of three adjacent electrodes 1407, 1408 and 1409 electrically connected in parallel and another group of three adjacent electrodes 1410, 1411 and 1412 electrically connected in parallel have a third sensing capacitance difference with an absolute value a3. With the absolute values a1, a2, a3 and a default quadratic equation, e.g. a parabolic equation C, an extremal value m, e.g. a maximal value, among the capacitance differences can be obtained. A position of the front end of the target object would be the position corresponding to the extremal value m, as illustrated in FIG. 3.

In an embodiment, the control circuit chip 111 transmits the sensing signal to the multimedia device 12 via wired or wireless means, wherein the multimedia device 12 may contain a virtual reality device 120. The multimedia signal outputted by the virtual reality device 120 dynamically varies with the sensing signal. For example, the information indicated by the sensing signal includes motional variations of the front end of the target object over time, such as changes in moving direction, speed, and reciprocating frequency. The virtual reality device 120 adjusts a virtual environment including video and audio outputs to the user based on the motional information. In other words, by sensing and transmitting the motional information of the target object to the virtual reality device 120 to reflect the condition of the target object in real time, an interactive effect can be achieved. Furthermore, the virtual reality device 120 can be designed to conduct a state change from a first state to a second state when the information satisfies a certain condition.

In an embodiment, the capacitive sensing device 11 senses motional information of the target object of the user, the virtual reality device 120 simulates a sensorial state of a virtual character that has the organ simulation device 10, and the reciprocating frequency of the motional organ (the target object) of the user is used for interpreting an excitatory level of the user. That is, different reciprocating frequency ranges indicate different excitatory levels. For example, four kinds of reciprocating frequency ranges indicate four kinds of excitatory degrees, respectively. During the interaction of the user with the virtual character, i.e. the interaction of the target object and the organ emulation device, the virtual reality device 120 dynamically presents the sensorial state of the virtual character according to the reciprocating frequency range of the target object. The reciprocating frequency range of the target object is calculated by averaging the reciprocating frequencies over a period of time and updated periodically or dynamically. Once the averaged reciprocating frequency reaches the topmost range, the virtual reality device 120 simulates an orgasm-climax state of the virtual character by outputting corresponding audio and video effects and/or further images.

In an embodiment, the interactive device may further include at least one auxiliary device 13 in communication with the multimedia device 12. Each the auxiliary device 13 is activated and adjusted in conformity with the multimedia signal. For example, the auxiliary device 13 is activated in response to a specific excitatory level, and conducts different operational levels, e.g. intensities or frequencies, in response to different excitatory levels, respectively. Alternatively, the at least one auxiliary device 13 may be coupled to the capacitive sensing device, and activated and adjusted based on the information carried by the sensing signal. The auxiliary device 13, for example only, may be in a form of a patch and attached onto the body of the user at a sexually sensitive position.

Furthermore, the moving direction and speed substantially reflect the impact force of the target object into the organ simulation device 10. Therefore, the virtual reality device 120 may alternatively or additionally simulate the excitatory level of the virtual character based on the moving direction and/or moving speed of the target object. Likewise, different impact forces render different excitatory levels. For example, four kinds of moving direction and/or speed ranges indicate four kinds of excitatory degrees, respectively. During the interaction of the user with the virtual character, i.e. the interaction of the target object and the organ emulation device, the virtual reality device 120 dynamically presents the sensorial state of the virtual character according to the moving direction and/or speed of the target object. The moving direction and/or speed of the target object is updated periodically or dynamically. With different levels of the moving direction and/or speed, the virtual reality device 120 simulates, for example, different moan patterns and/or levels of the virtual character with corresponding audio and video effects and/or further images. Likewise, the virtual reality device 120 may cooperate with the auxiliary device 13 to create a variety of enjoyable conditions.

In another embodiment, the multimedia device 12 is implemented with a video display device 121 and a sound playback device 123 of a computer or a smart phone without activating the virtual reality device 120. While the multimedia device 12 is executing an adult game, the output of the multimedia signal is dynamically adjusted in response to the sensor signal so that the information carried by the sensing signal can be merged into the game. For example, the information indicated by the sensing signal includes motional variations of the front end of the target object over time, such as changes in moving direction, speed, and reciprocating frequency. The video display device 121 and the sound playback device 123 respectively adjust their video and audio outputs based on the motional information. In other words, by sensing and transmitting the motional information of the target object to the multimedia device 12 to reflect the condition of the target object in real time, an interactive effect can be achieved. Furthermore, the multimedia device 12 can be designed to conduct a state change from a first state to a second state when the information satisfies a certain condition. The second state, for example, is an orgasm-climax state of the virtual character in the game.

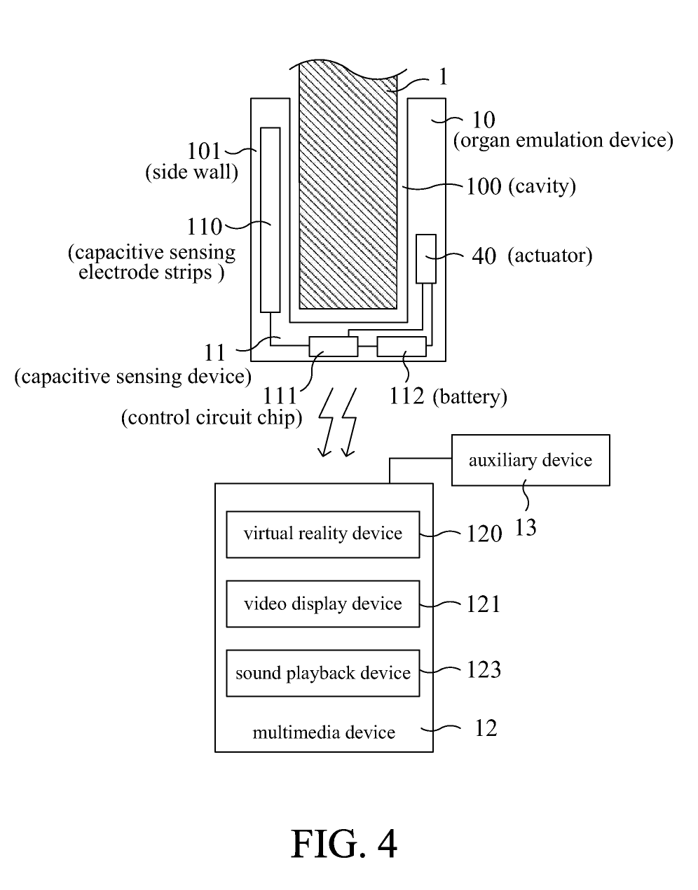

Please refer to FIG. 4, which schematically illustrates a functional block diagram of an interactive device according to another embodiment of the present invention. The interactive device in this embodiment differs from the embodiment illustrated in FIG. 1 in that the organ simulation device 10 further includes an actuator 40 disposed close to the body part of the user. The actuator 40, for example, may be an electric oscillator or a stepper motor, and actuated according to the information carried by the sensing signal, thereby enabling the organ simulation device 10 to respond to the action of the target object of the user. For example, when the state change from the first state to the second state occurs, the actuator 40 is triggered to make the organ simulation device 10 oscillate or deform, and/or add lubricant to the organ simulation device 10, thereby enhancing the interactive effect.

The organ simulation device 10 described in the above embodiments, for example, may be shaped like an artificial vagina or an artificial penis, or in any other shape that may achieve similar purposes.

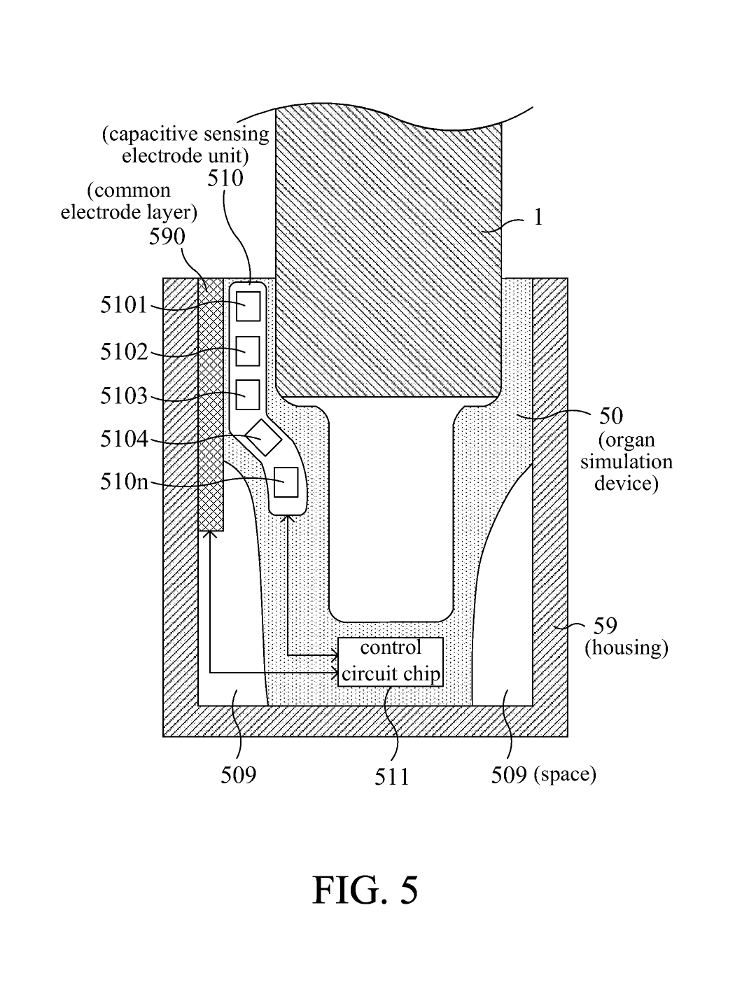

In an alternative embodiment as illustrated in FIG. 5, a relative motion of a body part 1 of a user, i.e. the target object, to an organ simulation device 50 can be determined by way of press sensing instead of touch sensing. As shown in FIG. 5, the organ simulation device 50 is covered by a housing 59, and embedded therein a control circuit chip 511 and a capacitive sensing electrode unit 510 including a plurality of separate electrodes 5101, 5102, . . . 510n allocated in a row. In a space 509 between the housing 59 and the organ simulation device 50, a common electrode layer 590 is disposed. Alternatively, the common electrode layer 590 may be embedded in the housing 59. In this embodiment, the organ simulation device 50 is made of an elastic material, e.g. silica gel. Therefore, when the body part 1 of the user contacts and presses the organ simulation device 50, the pressed portion of the organ simulation device 50 deforms so that the capacitance between one or more of the separate electrodes 5101, 5102, . . . 510n at the position corresponding to the pressed portion of the organ simulation device 50 and the common electrode layer changes. Once the control circuit chip 511 determines the capacitance change, a sensing signal is outputted by the control circuit chip 511 in response, and transmitted to the multimedia device 12. The multimedia device 12, when receiving the sensing signal, adaptively outputs a multimedia signal to reflect the information of the relative motion, which is carried by the sensing signal. The operations responding to the multimedia signal are similar to those described above in other embodiments, and are not intended to be redundantly described herein.

In an alternative embodiment, the dispositions of the common electrode layer 590 and the capacitive sensing electrode unit 510 are interchanged. That is, the common electrode layer 590 is disposed in the organ simulation device 50, and the capacitive sensing electrode unit 510 is disposed in the housing 59. Likewise, the control circuit chip 511 may be disposed in the housing 59 instead of the organ simulation device 50, or in the space 509 between the organ simulation device 50 and the housing 59.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interactive device, comprising:
an organ emulation device for contact with a body part of a user;
a capacitive sensing device disposed in the organ emulation device for sensing a relative motion of the body part of the user to the organ emulation device and outputting a sensing signal corresponding to the relative motion; and
a multimedia device in communication with the capacitive sensing device for receiving the sensing signal, and outputting a multimedia signal based on an information indicated by the sensing signal so as to respond to the relative motion.

2. The interactive device according to claim 1, wherein the organ emulation device is an artificial vagina or an artificial penis.

3. The interactive device according to claim 1, wherein the capacitive sensing device includes:
a plurality of sensing electrodes disposed in the organ emulation device for sensing the relative motion of the body part of the user to the organ emulation device; and
a control circuit chip electrically connected to the plurality of sensing electrodes for generating and outputting the sensing signal corresponding to the relative motion,
wherein a capacitance of at least one of the sensing electrodes changes with the relative motion of the body part of the user, and the control circuit chip generates the sensing signal in response to the capacitance change.

4. The interactive device according to claim 1, wherein the organ emulation device is covered with a housing, and the capacitive sensing device includes:
a plurality of sensing electrodes separately disposed in the organ emulation device and allocated in a row for sensing the relative motion of the body part of the user to the organ emulation device;
a control circuit chip electrically connected to the plurality of sensing electrodes for generating and outputting the sensing signal corresponding to the relative motion and
a common electrode layer disposed in a space between the organ emulation device and the housing, or embedded in the housing,
wherein a capacitance between at least one of the sensing electrodes and the common electrode layer changes with the relative motion of the body part of the user, which results in deformation of the organ simulation device so as to change a gap between the at least one of the sensing electrodes and the common electrode layer, and the control circuit chip generates the sensing signal in response to the capacitance change.

5. The interactive device according to claim 1, wherein the multimedia device includes a virtual reality device in communication with the capacitive sensing device for adjusting a virtual environment of the multimedia signal based on the information indicated by the sensing signal so as to respond to the relative motion.

6. The interactive device according to claim 1, wherein the multimedia device includes a video display device and a sound playback device in communication with the capacitive sensing device for adjusting video and audio outputs of the multimedia signal based on the information indicated by the sensing signal so as to respond to the relative motion.

7. The interactive device according to claim 1, further comprising at least one auxiliary device in communication with the multimedia device, wherein the auxiliary device is activated and adjusted in conformity with the multimedia signal.

8. The interactive device according to claim 7, wherein the auxiliary device is a patch attached onto another body part of the user.

9. The interactive device according to claim 1, wherein the organ simulation device further includes an actuator activated and adjusted according to the information carried by the sensing signal, thereby enabling the organ simulation device to respond to the relative motion of the body part of the user.

10. The interactive device according to claim 9, wherein the actuator is an oscillator or a stepper motor.

11. An organ emulation device for use with a multimedia device, comprising:
a main body for contact with a body part of a user; and
a capacitive sensing device disposed in the main body for sensing a relative motion of the body part of the user to the organ emulation device and outputting a sensing signal corresponding to the relative motion to the multimedia device to have the multimedia device dynamically respond to the relative motion.

12. The organ emulation device according to claim 11, wherein the main body is shaped as an artificial vagina or an artificial penis.

13. The organ emulation device according to claim 11, wherein the capacitive sensing device includes:
a plurality of sensing electrodes disposed in the main body for sensing the relative motion of the body part of the user to the main body; and
a control circuit chip electrically connected to the plurality of sensing electrodes for generating and outputting the sensing signal corresponding to the relative motion,
wherein a capacitance of at least one of the sensing electrodes changes with the relative motion of the body part of the user, and the control circuit chip generates the sensing signal in response to the capacitance change.

14. The organ emulation device according to claim 11, further comprising a housing covering the main body, and the capacitive sensing device includes:
a plurality of sensing electrodes separately disposed in the main body and allocated in a row for sensing the relative motion of the body part of the user to the main body;
a control circuit chip electrically connected to the plurality of sensing electrodes for generating and outputting the sensing signal corresponding to the relative motion and
a common electrode layer disposed in a space between the main body and the housing, or embedded in the housing,
wherein a capacitance between at least one of the sensing electrodes and the common electrode layer changes with the relative motion of the body part of the user, which results in deformation of the main body so as to change a gap between the at least one of the sensing electrodes and the common electrode layer, and the control circuit chip generates the sensing signal in response to the capacitance change.

15. The organ emulation device according to claim 1, wherein the multimedia device dynamically responds to the relative motion based on an information indicated by the sensing signal, which includes motional variations of a front end of the body part over time.

16. The organ emulation device according to claim 1, wherein the information indicated by the sensing signal includes changes in moving direction, speed, and reciprocating frequency.
